(19) United States
(12) Patent Application Publication
(10) Pub. No.: US 2025/0303548 A1
(43) Pub. Date: Oct. 2, 2025

(54) ROBOT AND ROBOT SYSTEM

(71) Applicant: SEIKO EPSON CORPORATION, Tokyo (JP)

(72) Inventor: Hiroki IGARASHI, MATSUMOTO-SHI (JP)

(21) Appl. No.: 19/092,978

(22) Filed: Mar. 27, 2025

(30) Foreign Application Priority Data
Mar. 28, 2024 (JP) 2024-055118

(51) Int. Cl. B25J 9/00; B25J 9/16; B25J 19/00

(52) U.S. Cl. CPC B25J 9/0009; B25J 9/1615; B25J 19/0004; B25J 19/0025

(57) ABSTRACT

A robot includes a base; a first arm that is coupled to the base and rotates around a first rotation axis with respect to the base; a second arm that is coupled to the first arm at a base end portion and rotates around a second rotation axis parallel to the first rotation axis with respect to the first arm; a first electronic component and a second electronic component that are disposed in the second arm; a relay circuit board disposed in the second arm; a first wiring line that electrically couples the relay circuit board and the first electronic component; a second wiring line that electrically couples the relay circuit board and the second electronic component; and a third wiring line routed to the base and the second arm and electrically coupled to the relay circuit board.

### CROSS-REFERENCE TO RELATED APPLICATIONS

The present application is based on, and claims priority from JP Application Serial Number 2024-055118, filed Mar. 28, 2024, the disclosure of which is hereby incorporated by reference herein in its entirety.

### BACKGROUND OF THE INVENTION

### 1. Technical Field

The present disclosure relates to a robot and a robot system.

### 2. Related Art

The SCARA robot (horizontal multi-joint robot) described in JP-A-2020-157428 includes a base, a first arm rotatably coupled to the base around a first rotation axis along a vertical direction, a second arm rotatably coupled to the first arm around a second rotation axis along the vertical direction, a tube that couples the base and the second arm, and a control board disposed in the base. Each electronic component disposed in the second arm is electrically coupled to the control board via the wiring line that is routed into the base and the second arm while passing through the tube.

As described above, in the SCARA robot described in JP-A-2020-157428, each electronic component disposed in the second arm is electrically coupled to the control board via the wiring line that is routed into the base and the second arm while passing through the tube. Therefore, the number of wiring lines passing through the tube tends to increase. Therefore, there is a concern that it takes time and effort to couple the wiring lines when assembling the robot.

### SUMMARY OF THE INVENTION

A robot according to an aspect of the present disclosure includes: a base; a first arm that is coupled to the base and rotates around a first rotation axis with respect to the base; a second arm that is coupled to the first arm at a base end portion and rotates around a second rotation axis parallel to the first rotation axis with respect to the first arm; a first electronic component and a second electronic component that are disposed in the second arm; a relay circuit board disposed in the second arm; a first wiring line that electrically couples the relay circuit board and the first electronic component; a second wiring line that electrically couples the relay circuit board and the second electronic component; and a third wiring line routed to the base and the second arm and electrically coupled to the relay circuit board.

A robot system according to another aspect of the present disclosure includes: a robot; and a control device controlling driving of the robot, in which the robot includes a base in which the control device is accommodated, a first arm that is coupled to the base and rotates around a first rotation axis with respect to the base, a second arm that is coupled to the first arm at a base end portion and rotates around a second rotation axis parallel to the first rotation axis with respect to the first arm, a first electronic component and a second electronic component that are disposed in the second arm, a relay circuit board disposed in the second arm, a first wiring line that electrically couples the relay circuit board and the first electronic component, a second wiring line that electrically couples the relay circuit board and the second electronic component, and a third wiring line that is routed between the second arm and the base and electrically couples the relay circuit board and the control device.

### BRIEF DESCRIPTION OF DRAWINGS

FIG. 1 is a side view illustrating a robot according to a preferred embodiment.

FIG. 2 is a sectional view illustrating a coupling portion between a base and a first arm.

FIG. 3 is a sectional view of a second arm viewed from one side in the horizontal direction.

FIG. 4 is a sectional view of the second arm viewed from the other side in the horizontal direction.

FIG. 5 is a top view showing the inside of the second arm.

FIG. 6 is an enlarged perspective view illustrating a tip end portion of a frame.

FIG. 7 is an enlarged sectional view illustrating the tip end portion of the frame.

### DETAILED DESCRIPTION OF THE INVENTION

Hereinafter, a robot and a robot system of the present disclosure will be described in detail based on the embodiment illustrated in the accompanying drawings.

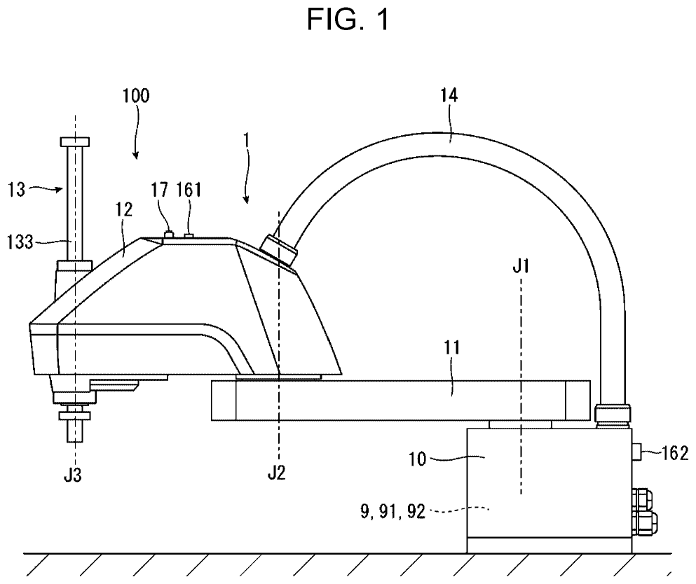

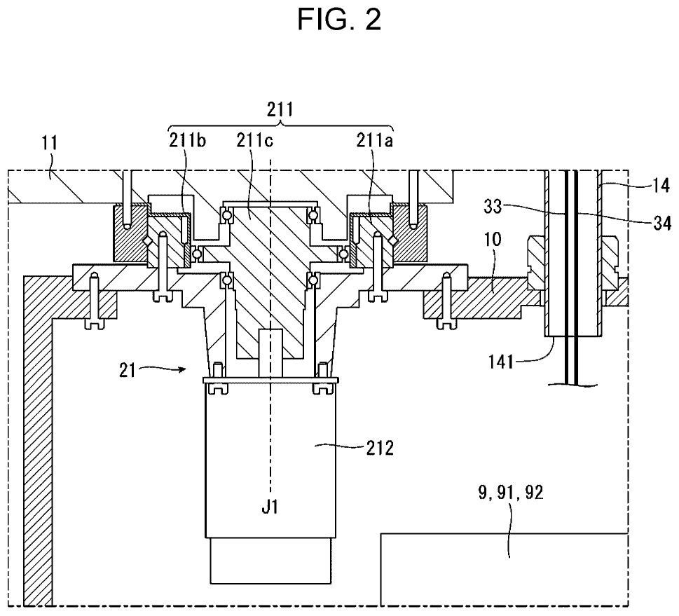

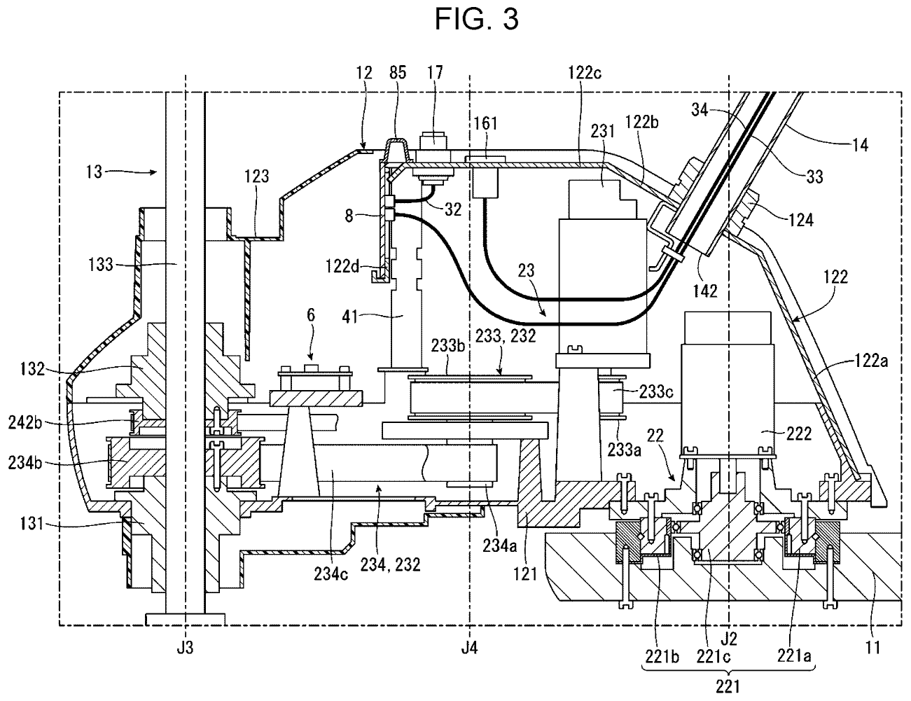

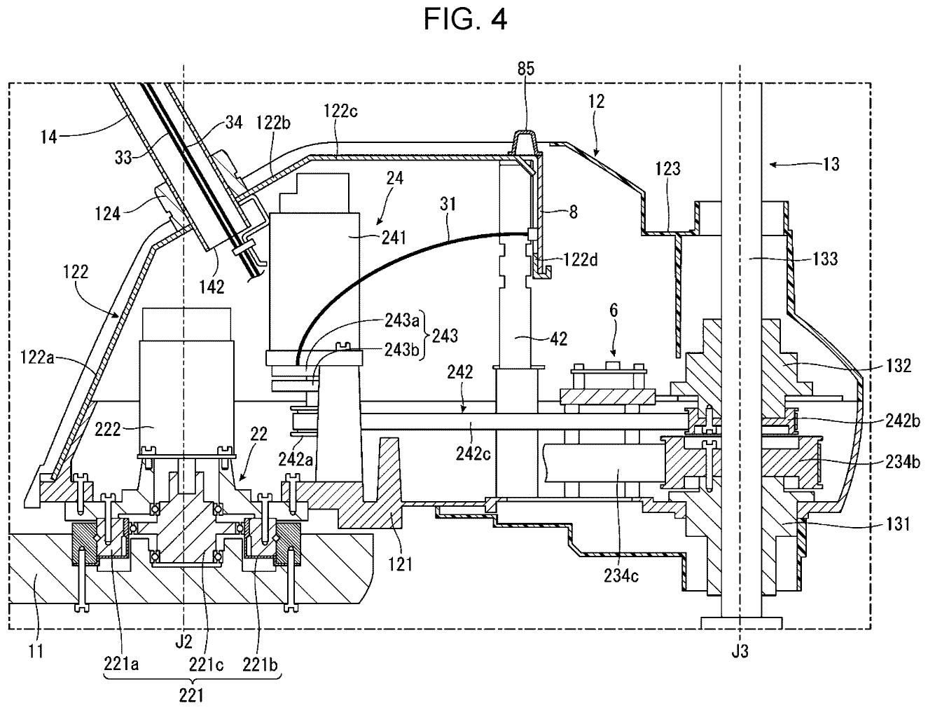

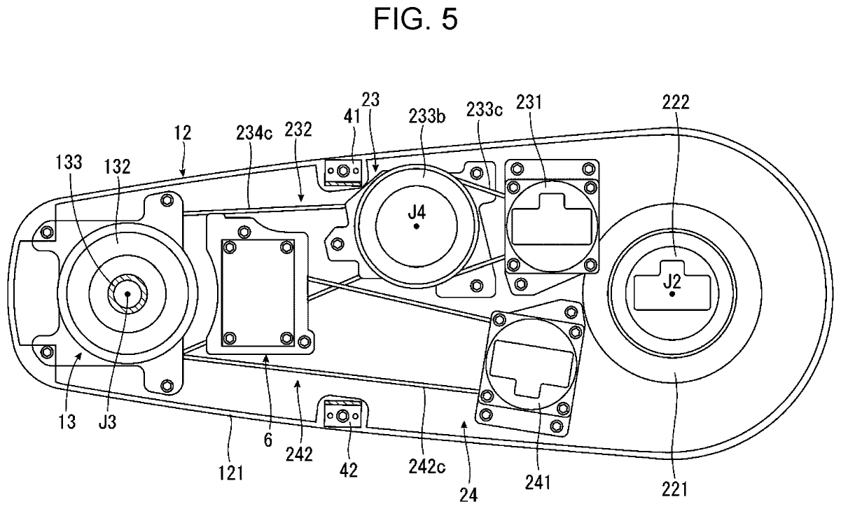

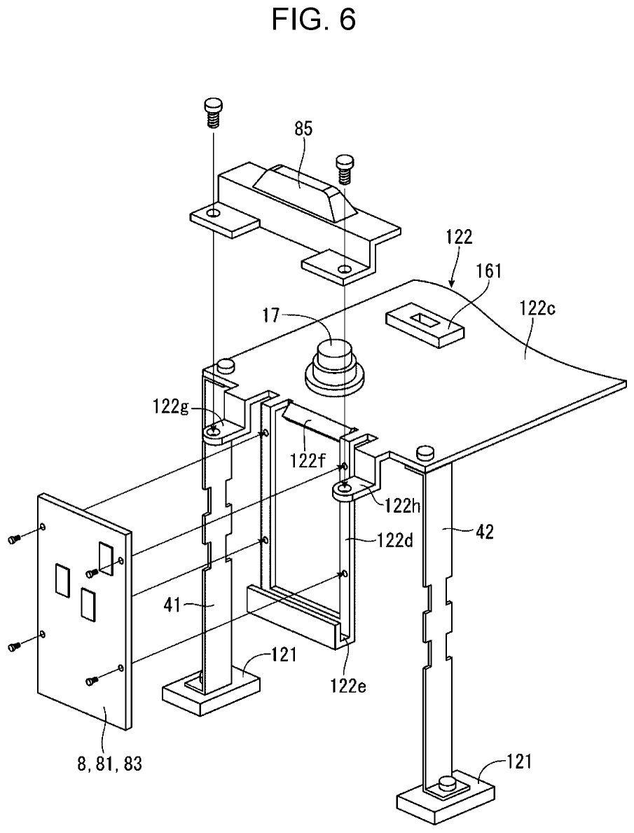

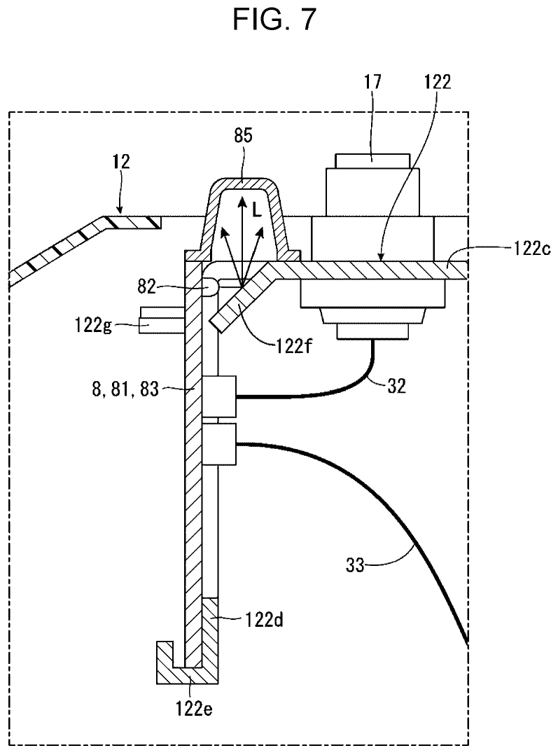

FIG. 1 is a side view illustrating a robot according to a preferred embodiment. FIG. 2 is a sectional view illustrating a coupling portion between a base and a first arm. FIG. 3 is a sectional view of a second arm viewed from one side in the horizontal direction. FIG. 4 is a sectional view of the second arm viewed from the other side in the horizontal direction. FIG. 5 is a top view illustrating the inside of the second arm. FIG. 6 is an enlarged perspective view illustrating a tip end portion of a frame. FIG. 7 is an enlarged sectional view illustrating the tip end portion of the frame.

The up-down direction in FIG. 1 coincides with the vertical direction. Therefore, in the following, the upper side in FIG. 1 is referred to as “up” and the lower side is referred to as “down”. In addition, in the present specification, the “vertical” includes not only a case of coinciding with the vertical, but also a case of being inclined with respect to the vertical within a range in which the effect of the present disclosure can be exhibited, for example, within ±5° with respect to the vertical. Similarly, in the present specification, “parallel” includes not only a case where two objects are parallel to each other, but also a case of being inclined with respect to the parallel within a range in which the effect of the present disclosure can be exhibited, for example, within ±5° with respect to the parallel.

A robot system 100 illustrated in FIG. 1 includes a robot 1 and a control device 9 that controls driving of the robot 1.

### Control Device 9

As illustrated in FIG. 1, the control device 9 includes, for example, a control board 91 and a power supply substrate 92. However, the present disclosure is not limited thereto, and the control board 91 and the power supply substrate 92 may be one substrate.

The control board 91 collectively controls the driving of each portion of the robot 1. The control board 91 includes a central processing unit (CPU), a random access memory (RAM), a read only memory (ROM), and the like. The above functions are achieved by the CPU reading and executing the program and data stored in the ROM. The control board 91 is electrically coupled to a host computer (not illustrated) and controls the driving of each section of the robot 1 based on a command from the host computer. However, the present disclosure is not limited thereto, and the circuits and the like of the control board 91 may be divided into a plurality of substrates.

The power supply substrate 92 supplies power to the control board 91. The power supply substrate 92 includes a conversion circuit. The conversion circuit converts power supplied from the outside into a predetermined value and supplies the power to the control board 91. The conversion circuit varies depending on the configuration of the robot 1, but examples of the conversion circuit include an AC-to-DC conversion circuit that converts an AC signal to a DC signal, a booster circuit or a buck circuit that converts a voltage level of a signal, and the like. However, the present disclosure is not limited thereto, and the circuits and the like of the power supply substrate 92 may be divided into a plurality of substrates. The configuration of the control device 9 is not particularly limited as long as the robot 1 can be controlled to be driven. In the present embodiment, the control device 9 is disposed in a base 10 of the robot 1, but the disposition of the control device 9 is not particularly limited. For example, the control device 9 may be installed outside the base 10. In this case, the robot 1 and the control device 9 may be coupled by a cable or may be wirelessly coupled.

### Robot 1

The robot 1 is a horizontal articulated robot (SCARA robot). As illustrated in FIG. 1, the robot 1 includes the base 10 fixed to a floor or the like, a first arm 11 rotatably coupled to the base 10, a second arm 12 rotatably coupled to the first arm 11, a work head 13 disposed on the second arm 12, and a duct 14 that couples the base 10 and the second arm 12.

As illustrated in FIG. 2, the first arm 11 is coupled to the base 10 at the base end portion thereof and rotates around a first rotation axis J1 along the vertical direction with respect to the base 10.

As illustrated in FIGS. 3 and 4, the second arm 12 is coupled to the first arm 11 at the base end portion thereof, and rotates around a second rotation axis J2 parallel to the first rotation axis J1 with respect to the first arm 11. The second arm 12 includes a hard arm base 121 coupled to the first arm 11, a frame 122 fixed to the arm base 121, and a cover 123 covering the arm base 121 from above the frame 122. For example, the arm base 121 and the frame 122 are made of a lightweight and hard metal material such as aluminum, and the cover 123 is made of a lightweight resin material.

In addition, the second arm 12 has an inertial sensor module 6 that measures the inertia of the second arm 12. The inertial sensor module 6 is disposed on the distal end side of the second arm 12 with respect to a brake control board 8, and detects at least one of the angular velocity or the acceleration of the second arm 12. The inertial sensor module 6 is disposed at a position overlapping a virtual center axis when a virtual line segment passing through the second rotation axis J2 and a third rotation axis J3 is taken as the virtual center axis in a plan view in the direction along the second rotation axis J2. However, the present disclosure is not limited thereto, and the inertial sensor module 6 may be disposed at a position that does not overlap the virtual center axis.

As illustrated in FIG. 1, the duct 14 is a tubular member (conduit tube) disposed outside the first arm 11, and directly couples the base 10 and the second arm 12 without passing through the first arm 11. As illustrated in FIGS. 2 to 4, the duct 14 has a base end opening 141 facing the inside of the base 10 and a tip end opening 142 facing the inside of the second arm 12. The base end portion of the duct 14 is coupled to the base 10 and the tip end portion is coupled to the second arm 12. As a result, the base 10 and the second arm 12 communicate with each other via the duct 14. A third wiring line 33 and a fourth wiring line 34 are routed to the base 10 and the second arm 12 via the duct 14. According to such a configuration, the third wiring line 33 and the fourth wiring line 34 can be routed to the base 10 and the second arm 12 without passing through the first arm 11. Therefore, the third wiring line 33 and the fourth wiring line 34 can be easily routed. For convenience of description, in each of the drawings, a third wiring line 33 and a fourth wiring line 34 are illustrated, but the number of the third wiring lines 33 and the number of the fourth wiring lines 34 are not particularly limited, and may be two or more. In addition, the third wiring line 33 and the fourth wiring line 34 are routed to the tip side of motors 231 and 241 through a gap between the motors 231 and 241, for example.

As illustrated in FIGS. 3 and 4, the work head 13 is disposed at the tip end portion of the second arm 12. In addition, the work head 13 has a spline nut 131 and a ball screw nut 132 coaxially disposed side by side in the vertical direction, and a spline shaft 133 which is a shaft inserted into the spline nut 131 and the ball screw nut 132. In such a work head 13, when the spline nut 131 is rotated, the spline shaft 133 rotates around the third rotation axis J3, which is the center axis of the spline shaft 133 and is parallel to the first rotation axis J1, and moves linearly (up and down) along the third rotation axis J3. When the ball screw nut 132 is rotated, the spline shaft 133 moves linearly along the third rotation axis J3. When both the spline nut 131 and the ball screw nut 132 are rotated, the spline shaft 133 rotates around the third rotation axis J3. Although not illustrated, an end effector according to the work is mounted on the lower end portion of the spline shaft 133.

As illustrated in FIGS. 2 and 3, the robot 1 includes a first arm driving mechanism 21 that rotates the first arm 11 around the first rotation axis J1 with respect to the base 10, and a second arm driving mechanism 22 that rotates the second arm 12 around the second rotation axis J2 with respect to the first arm 11.

As illustrated in FIG. 2, the first arm driving mechanism 21 includes a speed reducer 211 that rotatably couples the base 10 and the first arm 11, and an encoder built-in motor 212 disposed in the base 10. The motor 212 is a servomotor, in particular, a three-phase motor driven by a three-phase AC, and is fixed to the base 10. The speed reducer 211 is a wave gear device, and a circular spline 211a is fixed to the base 10, and a flex spline 211b is fixed to the first arm 11. In addition, the rotation axis of the motor 212 is fixed to a wave generator 211c. Therefore, the wave generator 211c rotates together with the rotation of the motor 212, and further, the flex spline 211b rotates with a predetermined deceleration ratio with respect to the rotation of the wave generator 211c. As a result, the first arm 11 rotates around the first rotation axis J1 with respect to the base 10. However, the configuration of the first arm driving mechanism 21 is not particularly limited.

As illustrated in FIGS. 3 and 4, the second arm driving mechanism 22 has the same configuration as the first arm driving mechanism 21, and includes a speed reducer 221 that rotatably couples the first arm 11 and the second arm 12, and an encoder built-in motor 222 disposed in the second arm 12. The motor 222 is a servomotor, in particular, a three-phase motor driven by a three-phase AC, and is fixed to the arm base 121. The speed reducer 221 is a wave gear device, and a circular spline 221a is fixed to the arm base 121, and a flex spline 221b is fixed to the first arm 11. In addition, the rotation axis of the motor 222 is fixed to a wave generator 221c. Therefore, the wave generator 221c rotates together with the rotation of the motor 222, and further, the flex spline 221b rotates with a predetermined deceleration ratio with respect to the rotation of the wave generator 221c. As a result, the second arm 12 rotates around the second rotation axis J2 with respect to the first arm 11. However, the configuration of the second arm driving mechanism 22 is not particularly limited.

As illustrated in FIGS. 3 to 5, the robot 1 includes a spline shaft first driving mechanism 23 that rotates the spline nut 131 to rotate and linearly move the spline shaft 133, and a spline shaft second driving mechanism 24 that rotates the ball screw nut 132 to linearly move the spline shaft 133.

As illustrated in FIG. 3, the spline shaft first driving mechanism 23 has the encoder built-in motor 231 disposed in the second arm 12 and a speed reduction mechanism 232 that transmits the rotation of the motor 231 to the spline nut 131. The motor 231 is a servomotor, in particular, a three-phase motor driven by a three-phase AC, and is fixed to the arm base 121.

The speed reduction mechanism 232 has a first speed reduction mechanism 233 and a second speed reduction mechanism 234. The first speed reduction mechanism 233 includes a first pulley 233a attached to the rotation axis of the motor 231, a first intermediate pulley 233b supported to be rotatable around a fourth rotation axis J4 parallel to the second rotation axis J2 with respect to the arm base 121, and a first belt 233c wound around the first pulley 233a and the first intermediate pulley 233b. The first intermediate pulley 233b has a larger diameter than the first pulley 233a. The second speed reduction mechanism 234 includes a second intermediate pulley 234a that is coaxially disposed with the first intermediate pulley 233b and rotates around the fourth rotation axis J4 together with the first intermediate pulley 233b, a second pulley 234b attached to the spline nut 131, and a second belt 234c wound around the second intermediate pulley 234a and the second pulley 234b. The second intermediate pulley 234a has a smaller diameter than the first intermediate pulley 233b, and the second pulley 234b has a larger diameter than the second intermediate pulley 234a.

In such a configuration, the rotation of the motor 231 is transmitted to the first intermediate pulley 233b via the first pulley 233a and the first belt 233c, and the first intermediate pulley 233b and the second intermediate pulley 234a rotate integrally around the fourth rotation axis J4. The rotation of the second intermediate pulley 234a is transmitted to the second pulley 234b via the second belt 234c, and the second pulley 234b and the spline nut 131 integrally rotate around the third rotation axis J3. As a result, the spline shaft 133 rotates and moves linearly. As described above, by using the speed reduction mechanism 232 including the first speed reduction mechanism 233 and the second speed reduction mechanism 234, the rotation of the motor 231 can be reduced in two stages, and the spline nut 131 can be rotated with a larger torque. However, the configuration of the spline shaft first driving mechanism 23 is not particularly limited.

As illustrated in FIG. 4, the spline shaft second driving mechanism 24 includes the encoder built-in motor 241 disposed in the second arm 12, a speed reduction mechanism 242 that transmits the rotation of the motor 241 to the ball screw nut 132, and a brake 243 as a first electronic component that regulates the rotation of the spline shaft 133. The motor 241 is a servomotor, particularly a three-phase motor driven by a three-phase AC, and is fixed to the arm base 121. The speed reduction mechanism 242 includes a first pulley 242a attached to the rotation axis of the motor 241, a second pulley 242b attached to the ball screw nut 132, and a belt 242c wound around the first pulley 242a and the second pulley 242b. In such a configuration, the rotation of the motor 241 is transmitted to the second pulley 242b via the first pulley 242a and the belt 242c, and the second pulley 242b and the ball screw nut 132 integrally rotate around the third rotation axis J3. As a result, the spline shaft 133 linearly moves. As described above, the rotation of the motor 241 can be decelerated by using the speed reduction mechanism 242, and the ball screw nut 132 can be rotated with a sufficiently large torque. However, the configuration of the spline shaft second driving mechanism 24 is not particularly limited.

The brake 243 is an electromagnetic brake attached to the motor 241, and has a pair of plates 243a and 243b disposed to face each other. In addition, one plate 243a is fixed to the motor 241, and the other plate 243b is fixed to the rotation axis of the motor 241 and rotates together with the rotation axis. The brake state in which the plates 243a and 243b are in contact and the brake release state in which the plates 243a and 243b are separated are switched by ON/OFF control of the power supply. In particular, the brake 243 of the present embodiment is an unexcited operation type electromagnetic brake, and is in a brake release state when power is supplied (ON) and is in a brake state when power is cut off (OFF). Therefore, the power-on time can be shortened, and the power saving of the robot system 100 can be achieved. However, the configuration and disposition of the brake 243 are not particularly limited. For example, the brake 243 may be an excitation operation type electromagnetic brake that is in a brake state when power is supplied (ON) and is in a brake release state when power supply is cut off (OFF), or may be a brake such as an oil pressure type brake other than an electromagnetic brake. In addition, the brake 243 may be attached to, for example, the first pulley 242a, the second pulley 242b, or the ball screw nut 132.

The configuration of the main portion of the robot 1 is briefly described above. Next, the second arm 12 will be described in more detail.

As described above, the second arm 12 includes the hard arm base 121 coupled to the first arm 11, the frame 122 fixed to the arm base 121 and holding the duct 14, and the cover 123 covering the arm base 121 from above the frame 122.

The frame 122 is formed by, for example, press forming a sheet metal. As illustrated in FIGS. 3 and 4, the frame 122 protrudes obliquely upward from the base end portion of the arm base 121 toward the distal end side of the second arm 12. In addition, the frame 122 is a cantilever beam, and the base end portion is a fixed end fixed to the arm base 121, and the tip end portion is a free end. The frame 122 substantially has a shape in which the strip-shaped sheet metal is bent on the same side at three locations in the middle, and has a configuration in which a first portion 122a, a second portion 122b, a third portion 122c, and a fourth portion 122d, in which the directions of the plate surfaces are different from each other, are arranged from the base end side.

In addition, the inclination angle with respect to the second rotation axis J2 is increased in a stepwise manner from the first portion 122a to the third portion 122c. That is, the inclination angle of the first portion 122a<the inclination angle of the second portion 122b<the inclination angle of the third portion 122c. In particular, in the present embodiment, the inclination angle of the third portion 122c is 90°. That is, the third portion 122c is orthogonal to the second rotation axis J2, and the plate surface faces the vertical direction. Further, the fourth portion 122d is bent perpendicularly downward with respect to the third portion 122c, and the inclination angle with respect to the second rotation axis J2 is 0°. That is, the fourth portion 122d is parallel to the second rotation axis J2, and the plate surface faces the horizontal direction (the direction in which the second arm 12 extends).

As illustrated in FIGS. 6 and 7, a plate-shaped light reflection portion 122f bent by 45° downward with respect to the third portion 122c is formed at the tip end portion of the third portion 122c. The U-shaped fourth portion 122d extends downward from both sides of the light reflection portion 122f. In addition, the lower end portion of the fourth portion 122d is bent by 180° on the tip side. Therefore, a recessed portion 122e is formed at the lower end portion of the fourth portion 122d. In addition, crank-shaped support pieces 122g and 122h extending from the tip end portion of the third portion 122c are disposed on both sides of the fourth portion 122d. The recessed portion 122e may not be provided at the lower end portion of the fourth portion 122d.

As illustrated in FIGS. 3 and 4, the frame 122 is fixed to the arm base 121 in the first portion 122a. Further, a coupling portion 124 to which the duct 14 is coupled is disposed in the second portion 122b. The duct 14 is fixed to the coupling portion 124 in a state where the tip end portion of the duct 14 is inserted into the coupling portion 124. As a result, the duct 14 is held by the frame 122. Further, the coupling portion 124 is positioned above the second rotation axis J2 and intersects the second rotation axis J2. Therefore, the deformation of the duct 14 when the second arm 12 rotates around the second rotation axis J2 can be suppressed to be small, and the stress applied to the duct 14, and the third wiring line 33 and the fourth wiring line 34 passing through the duct 14 can be reduced. However, the position of the coupling portion 124 is not particularly limited, and may not overlap the second rotation axis J2.

In addition, as illustrated in FIGS. 3 and 6, a connector 161 and a brake release button 17 as the second electronic component for releasing the brake 243 of the spline shaft second driving mechanism 24 are disposed in the third portion 122c. The connector 161 and the brake release button 17 are exposed to the outside of the second arm 12 without being covered with the cover 123. Therefore, the user can easily access the connector 161 and the brake release button 17. As illustrated in FIG. 1, a connector 162 that forms a pair with the connector 161 is disposed on the back surface of the base 10, and the connectors 161 and 162 are coupled to each other via the fourth wiring line 34 that is routed through the duct 14 to the base 10 and the second arm 12. The fourth wiring line 34 is not limited to the wiring line for transmitting and receiving an electric signal, and means, for example, a pipe for sending compressed air. That is, when the fourth wiring line 34 is an electric wiring line, the connectors 161 and 162 are connectors for electric signals, and when the fourth wiring line 34 is a pipe for compressed air, the connectors 161 and 162 are connectors for compressed air. The number of the connectors 161 and 162 is not particularly limited, and can be appropriately set according to the function of the robot 1.

As illustrated in FIG. 6, the third portion 122c is supported by the arm base 121 via support members 41 and 42 on both sides thereof. As described above, since the frame 122 is a cantilever beam, the free end side is easily bent up and down. Therefore, for example, the third portion 122c is displaced downward by the downward stress applied when the user inserts the connector into the connector 161, when the user presses the brake release button 17, or when the wiring line or the device coupled to the connector 161 is installed on the frame 122, and the frame 122 may be plastically deformed. Therefore, by supporting the third portion 122c with the support members 41 and 42, the displacement of the third portion 122c to the lower side is suppressed, and the deformation of the frame 122 can be effectively suppressed. In particular, according to the present embodiment, the third portion 122c to which a force is applied when the user inserts the connector into the connector 161 or presses the brake release button 17 can be directly supported by the support members 41 and 42, and the above-described effect is more remarkable.

As illustrated in FIGS. 6 and 7, a lens 85 is fixed to the pair of support pieces 122g and 122h. The lens 85 is exposed to the outside of the second arm 12. In addition, the lens 85 is positioned on the distal end side of the second arm 12 with respect to the connector 161 and the brake release button 17. In addition, the lens 85 is positioned directly above the light reflection portion 122f.

As illustrated in FIGS. 6 and 7, the brake control board 8, which is a relay circuit board that controls the brake 243, is fixed to the fourth portion 122d. Specifically, the brake control board 8 is screwed to the fourth portion 122d. The brake control board 8 may be screwed to the fourth portion 122d in a state where the lower end portion thereof is inserted into the recessed portion 122e of the fourth portion 122d. With such a configuration, the fourth portion 122d can be screwed to the brake control board 8 in a state where the brake control board 8 is supported by the recessed portion 122e. Therefore, the brake control board 8 can be easily fixed to the fourth portion 122d. In a state of being fixed to the fourth portion 122d, the plate surface of the brake control board 8 faces the horizontal direction (the direction in which the second arm 12 extends). In the present embodiment, the fourth portion 122d has a U-shape, and an opening is formed in the part that overlaps the brake control board 8. Therefore, the interference between the brake control board 8 and the fourth portion 122d is suppressed.

As illustrated in FIGS. 3 and 4, the brake control board 8 is electrically coupled to the control board 91 via the third wiring line 33. Further, the brake control board 8 is electrically coupled to the brake 243 via the first wiring line 31 and is electrically coupled to the brake release button 17 via the second wiring line 32. The first wiring line 31 includes a total of two lines of a power line and a GND line coupled to the brake 243, and the second wiring line 32 includes at least three signal lines coupled to the brake release button 17. The third wiring line 33 includes at least a total of four lines of a power line and a GND line coupled to the brake 243 and a power line and a GND line coupled to a light emitting element control circuit 83. The third wiring line 33 may include three signal lines coupled to the brake release button 17. In addition, in the illustrated configuration, connectors coupled to the first, second, and third wiring lines 31, 32, and 33 are disposed on the back surface (surface on the proximal end side of the second arm 12) of the brake control board 8. However, the present disclosure is not limited thereto, and each of the connectors may be disposed on the front surface (surface on the distal end side of the second arm 12) of the brake control board 8. As described above, the brake control board 8 disposed in the second arm 12 performs relaying between the brake 243 and the brake release button 17, and the control board 91, so that the wiring line passing through the duct 14 which is provided separately for each electronic component to be coupled can be aggregated. As a result, the number of wiring lines passing through the duct 14 can be reduced.

Specifically, the number of wiring lines passing through the duct 14 is two, which is the third wiring line 33 and the fourth wiring line 34. On the other hand, for example, when the brake control board 8 is not provided, the brake 243 is electrically coupled to the control board 91 via the wiring line passing through the duct 14, the brake release button 17 is electrically coupled to the control board 91 via the wiring line passing through the duct 14, and the light emitting element control circuit 83 is electrically coupled to the control board 91 via the wiring line passing through the duct 14, the number of wiring lines passing through the duct 14 is the number obtained by adding the fourth wiring line 34 to the three wiring lines. As is clear from the comparison, according to the robot 1, the number of wiring lines passing through the duct 14 can be reduced. Therefore, for example, the labor of coupling the wiring lines at the time of assembling the robot 1 can be reduced. In addition, the diameter of the duct 14 can be reduced and the duct 14 can be lightened.

As illustrated in FIGS. 6 and 7, the brake control board 8 includes a brake control circuit 81. The brake control circuit 81 controls the driving of the brake 243 based on the command from the control board 91, and switches the brake state/brake release state. The brake control circuit 81 controls the driving of the brake 243 based on the operation of the brake release button 17, and switches the brake state/brake release state.

Here, the brake release button 17 is used, for example, when the user directly moves the robot 1 with his/her own hand and directly teaches the operation to the robot 1. In a state where the spline shaft 133 is stopped, the brake 243 is in a brake state. This is because there is a concern that the spline shaft 133 may move downward on its own due to the weight applied to the spline shaft 133. Therefore, the user cannot linearly move the spline shaft 133 along the third rotation axis J3. Therefore, the user operates, that is, presses the brake release button 17 when the user wants to linearly move the spline shaft 133 along the third rotation axis J3. The brake control circuit 81 that has detected the pressing of the brake release button 17 controls the driving of the brake 243 to be in the brake release state, and allows the linear movement of the spline shaft 133 along the third rotation axis J3. In this state, the user moves the spline shaft 133 to a predetermined position and presses the brake release button 17 again. The brake control circuit 81 that has detected the pressing of the brake release button 17 controls the driving of the brake 243 to be in the brake state. By appropriately performing the switching between the brake state and the brake release state, the direct teaching can be smoothly performed. However, the use timing of the brake release button 17 is not limited to the time of the direct teaching.

As illustrated in FIG. 7, the robot 1 includes a light emitting element 82 mounted on the brake control board 8. The light emitting element 82 is, for example, a light emitting diode (LED). The light emitting element 82 of the present embodiment includes a red LED that emits red light, a green LED that emits green light, and a blue LED that emits blue light, and can generate full-color light L by adjusting the light emission intensity of each LED. However, the configuration of the light emitting element 82 is not particularly limited. For example, the light emitting element 82 may include at least one of a red LED that emits red light, a green LED that emits green light, and a blue LED that emits blue light.

Such a light emitting element 82 is disposed on the back surface of the brake control board 8 and faces the light reflection portion 122f. The light emitting element 82 emits the light L toward the light reflection portion 122f. The light L emitted from the light emitting element 82 is reflected upward by the light reflection portion 122fand then enters the lens 85. As a result, the lens 85 emits light. Therefore, it is possible to notify the user of various information via the lens 85 by switching the lighting/blinking/extinguishing of the lens 85 or by switching the color of the lens 85. In particular, in the present embodiment, fine irregularities are formed on the surface of the lens 85. Therefore, the wide area of the lens 85 can be uniformly illuminated, and the user can more easily confirm the light emission state of the lens. The surface of the light reflection portion 122f may be formed with fine irregularities. According to the configuration in which the light L of the light emitting element 82 is reflected by the light reflection portion 122f and guided to the lens 85, it is not necessary to align the light emitting element 82 and the lens 85, and the degree of freedom in the arrangement thereof is increased.

As illustrated in FIGS. 6 and 7, the brake control board 8 includes the light emitting element control circuit 83 that controls driving of the light emitting element 82. As a result, it is possible to aggregate the wiring line passing through the duct 14 that is provided to be divided into the wiring line coupled to the brake 243 and the wiring line coupled to the light emitting element control circuit 83. The light emitting element control circuit 83 emits light L of a predetermined color from the light emitting element 82 and causes the lens 85 to emit light while power is supplied to the motors 212, 222, 231, and 241, that is, while the power of the robot 1 is turned on. Hereinafter, this state is also referred to as a first light emission state. As a result, it is possible to easily notify the user that the power of the robot 1 is turned on. Further, when the brake release button 17 is pressed and the brake 243 is in the brake release state, the light emitting element control circuit 83 emits light L of a color different from the first light emission state from the light emitting element 82 to cause the lens 85 to emit light. Hereinafter, this state is also referred to as a second light emission state. As a result, the user can be easily notified that the brake 243 is in the brake release state. Further, by switching between the first light emission state and the second light emission state, it is possible to notify the user of the state of the robot 1 more clearly. However, the notification method is not particularly limited, and for example, the first light emission state may be turned on and the second light emission state may be turned off, or the first light emission state may be turned on and the second light emission state may be blinked. Further, the light emitting element control circuit 83 may be provided on a substrate different from the brake control board 8.

The brake control board 8 as described above includes a central processing unit (CPU), a read only memory (ROM), and the like. The above functions are achieved by the CPU reading and executing the program and data stored in the ROM.

As described above, in the robot 1, the duct 14, the brake control board 8, the connector 161, and the brake release button 17 are held by the frame 122. Therefore, these components can be unitized, and the robot 1 can be easily assembled. In particular, in the present embodiment, the connector 161 is located on the duct 14 side with respect to the brake control board 8. In other words, the connector 161 is located between the brake control board 8 and the tip end opening 142. By adopting such an arrangement, it is difficult for the coupling of the fourth wiring line 34 to the connector 161 to be disturbed by the brake control board 8. Therefore, the fourth wiring line 34 can be easily coupled to the connector 161. Further, the length of the fourth wiring line 34 can be shortened.

The robot system 100 is described above. As described above, the robot 1 included in the robot system 100 includes the base 10, the first arm 11 that is coupled to the base 10 and rotates around the first rotation axis JI with respect to the base 10, the second arm 12 that is coupled to the first arm 11 at the base end portion and rotates around the second rotation axis J2 parallel to the first rotation axis J1 with respect to the first arm 11, the brake 243 as the first electronic component and the brake release button 17 as the second electronic component that are disposed in the second arm 12, the brake control board 8 as the relay circuit board that is disposed in the second arm 12, the first wiring line 31 that electrically couples the brake control board 8 and the brake 243, the second wiring line 32 that electrically couples the brake control board 8 and the brake release button 17, and the third wiring line 33 routed to the base 10 and the second arm 12 and electrically coupled to the brake control board 8. According to such a configuration, the number of wiring lines routed to the base 10 and the second arm 12 can be reduced. Therefore, for example, the labor of coupling the wiring lines at the time of assembling the robot 1 can be reduced.

In addition, as described above, the robot 1 includes the spline shaft 133 that is disposed in the second arm 12 and is a shaft that moves along the third rotation axis J3 parallel to the first rotation axis J1 with respect to the second arm 12, the motor 241 that is disposed in the second arm 12 and causes the spline shaft 133 to move linearly along the third rotation axis J3 with respect to the second arm 12, the brake 243 as the first electronic component that switches between the brake state of blocking the movement of the spline shaft 133 and the brake release state of allowing the movement of the spline shaft 133, and the brake release button 17 as the second electronic component that switches the brake 243 from the brake state to the brake release state, and the brake control board 8 includes the brake control circuit 81 that controls the brake 243 according to the operation of the brake release button 17. According to such a configuration, it is not necessary to route the first wiring line 31 and the second wiring line 32 from the second arm 12 to the base 10. Therefore, the number of wiring lines routed to the base 10 and the second arm 12 can be reduced.

Further, as described above, the robot 1 includes the duct 14 that couples the base 10 and the second arm 12, has a tubular shape with the base end opening 141 facing the inside of the base 10 and the tip end opening 142 facing the second arm 12, and has the third wiring line 33 inserted therein. Further, the second arm 12 includes the arm base 121 coupled to the first arm 11, and the frame 122 fixed to the arm base 121 and holding the duct 14. The brake control board 8 is held by the frame 122. According to such a configuration, the components including the frame 122, and the duct 14 and the brake control board 8 attached to the frame 122 can be unitized. Therefore, the robot 1 can be easily assembled.

Further, as described above, the robot 1 includes the light emitting element 82 mounted on the brake control board 8, and the brake control board 8 includes the light emitting element control circuit 83 that causes the light emitting element 82 to emit light in a state where power is supplied to the motor 241. According to such a configuration, it is possible to easily notify the user that the power is supplied to the motor 241, and it is possible to reduce the number of wiring lines routed to the base 10 and the second arm 12. Therefore, for example, the labor of coupling the wiring lines at the time of assembling the robot 1 can be reduced.

Further, as described above, the robot 1 includes the lens 85 that faces the outside of the second arm 12 and into which the light L of the light emitting element 82 enters. Further, the frame 122 includes the light reflection portion 122f that diffusely reflects the light L of the light emitting element 82 toward the lens 85. As described above, since the light reflection portion 122f is provided, it is not necessary to align the light emitting element 82 and the lens 85, and the degree of freedom in the arrangement of the light emitting element 82 and the lens 85 is increased. Further, the light reflection portion 122f can uniformly illuminate the lens 85 by diffusely reflecting the light L.

Further, as described above, the robot 1 includes the connector 161 disposed in the second arm 12 and positioned between the brake control board 8 and the tip end opening 142 in a plan view in a direction along the second rotation axis J2, and the fourth wiring line 34 electrically coupled to the connector 161 and routed into the second arm 12 and the base 10 via the duct 14. As described above, by disposing the connector 161 between the brake control board 8 and the tip end opening 142, it is difficult for the coupling of the fourth wiring line 34 to the connector 161 to be hindered by the brake control board 8. Therefore, the fourth wiring line 34 can be easily coupled to the connector 161. In addition, the length of the fourth wiring line 34 can also be shortened.

Further, as described above, the robot system 100 includes the robot 1 and the control device 9 that controls the driving of the robot 1. In addition, the robot 1 includes the base 10 in which the control device 9 is accommodated, the first arm 11 that is coupled to the base 10 and rotates around the first rotation axis J1 with respect to the base 10, the second arm 12 that is coupled to the first arm 11 at the base end portion and rotates around the second rotation axis J2 parallel to the first rotation axis J1 with respect to the first arm 11, the brake 243 as the first electronic component and the brake release button 17 as the second electronic component that are disposed in the second arm 12, the brake control board 8 as the relay circuit board that is disposed in the second arm 12, the first wiring line 31 that electrically couples the brake control board 8 and the brake 243, the second wiring line 32 that electrically couples the brake control board 8 and the brake release button 17, and the third wiring line 33 that is routed between the second arm 12 and the base 10 and electrically couples the brake control board 8 and the control device 9. According to such a configuration, the number of wiring lines routed to the base 10 and the second arm 12 can be reduced. Therefore, for example, the labor of coupling the wiring lines at the time of assembling the robot 1 can be reduced.

The robot and the robot system of the present disclosure are described above based on the illustrated embodiment, but the present disclosure is not limited thereto, and the configuration of each section can be replaced with any configuration having the same function. Additionally, any other components may be added to the present disclosure.

For example, in the above-described embodiment, the robot 1 has the duct 14, but the duct 14 may be omitted. In this case, the third wiring line 33 and the fourth wiring line 34 are routed to the base 10 and the second arm 12 passing through the first arm 11.

In addition, in the above-described embodiment, the first electronic component is the brake 243, the second electronic component is the brake release button 17, and the relay circuit board is the brake control board 8, but the first electronic component, the second electronic component, and the relay circuit board are not particularly limited. For example, the first electronic component may be the motor 231, the second electronic component may be the motor 241, and the relay circuit board may be an inertia sensor control board that performs relaying between the motors 231 and 241 and the control device 9, and controls the driving of the motors 231 and 241 according to the instruction from the control device 9. In addition, for example, when the angular velocity sensor and the acceleration sensor are mounted on the second arm 12, the first electronic component may be the angular velocity sensor, the second electronic component may be the acceleration sensor, and the relay circuit board may be an inertia sensor control board that performs relaying between the angular velocity sensor and the acceleration sensor, and the control device 9, and controls the driving of the angular velocity sensor and the acceleration sensor in response to the instruction from the control device 9. In addition, in the above-described embodiment, the robot 1 is a floor-standing type SCARA robot in which the base 10 is fixed to the floor or the like, but may be a ceiling-suspended type SCARA robot in which the base 10 is suspended from the ceiling. In this case, the base 10 is suspended from, for example, a top plate located at the upper portion of a stand having a frame-shaped leg portion.

1. A robot comprising:
a base;
a first arm that is coupled to the base and rotates around a first rotation axis with respect to the base;
a second arm that is coupled to the first arm at a base end portion and rotates around a second rotation axis parallel to the first rotation axis with respect to the first arm;
a first electronic component and a second electronic component that are disposed in the second arm;
a relay circuit board disposed in the second arm;
a first wiring line that electrically couples the relay circuit board and the first electronic component;
a second wiring line that electrically couples the relay circuit board and the second electronic component; and
a third wiring line routed to the base and the second arm and electrically coupled to the relay circuit board.

2. The robot according to claim 1, further comprising:
a shaft that is disposed in the second arm and performs movement along a third rotation axis parallel to the first rotation axis with respect to the second arm;
a motor that is disposed in the second arm and causes the shaft to linearly move along the third rotation axis with respect to the second arm; and
a brake as the first electronic component that switches between a brake state of preventing the movement of the shaft and a brake release state of allowing the movement of the shaft; and
a brake release button as the second electronic component that switches the brake from the brake state to the brake release state, wherein
the relay circuit board includes a brake control circuit that controls the brake according to an operation of the brake release button.

3. The robot according to claim 2, further comprising a duct that couples the base and the second arm, has a tubular shape with a base end opening facing an inside of the base and a tip end opening facing the second arm, and has the third wiring line inserted therethrough, wherein
the second arm includes an arm base coupled to the first arm and a frame fixed to the arm base and holding the duct, and
the relay circuit board is held by the frame.

4. The robot according to claim 3, further comprising a light emitting element mounted on the relay circuit board, wherein
the relay circuit board includes a light emitting element control circuit that causes the light emitting element to emit light in a state where power is supplied to the motor.

5. The robot according to claim 4, further comprising a lens that faces an outside of the second arm and into which light of the light emitting element enters, wherein
the frame includes a light reflection portion that diffusely reflects the light of the light emitting element toward the lens.

6. The robot according to claim 5, further comprising:
a connector disposed in the second arm and positioned between the relay circuit board and the tip end opening in a plan view in a direction along the second rotation axis; and
a fourth wiring line electrically coupled to the connector and routed to the second arm and the base via the duct.

7. A robot system comprising:
a robot; and
a control device controlling driving of the robot, wherein
the robot includes
a base in which the control device is accommodated,
a first arm that is coupled to the base and rotates around a first rotation axis with respect to the base,
a second arm that is coupled to the first arm at a base end portion and rotates around a second rotation axis parallel to the first rotation axis with respect to the first arm,
a first electronic component and a second electronic component that are disposed in the second arm,
a relay circuit board disposed in the second arm,
a first wiring line that electrically couples the relay circuit board and the first electronic component,
a second wiring line that electrically couples the relay circuit board and the second electronic component, and
a third wiring line that is routed between the second arm and the base and electrically couples the relay circuit board and the control device.
